(19) United States
(12) Patent Application Publication
(10) Pub. No.: US 2004/0244297 A1
(43) Pub. Date: Dec. 9, 2004

(54) Sealing profile, in particular for the door of a refrigeration appliance

(76) Inventors: Peter Schuster, Erlangen (DE); Jorg Muhlstadt, Gerhardshofen (DE)

Correspondence Address: VENABLE, BAETJER, HOWARD AND CIVILETTI, LLP, P.O. BOX 34385, WASHINGTON, DC, 20043-9998, US

(21) Appl. No.: 10/488,690

(22) PCT Filed: Aug. 30, 2002
(86) PCT No.: PCT/EP02/09669

(30) Foreign Application Priority Data
Sep. 8, 2001 (DE) 201 14 870.6

(51) Int. Cl. E06B 7/16

(52) U.S. Cl. 49/478.1

(57) ABSTRACT

The invention relates to a sealing profile, in particular for the door of a refrigeration appliance. The profile comprises a hollow cross-section, a sealing chamber for a magnetic strip, a sealing foot that can be fixed to the interior of the door and a sealing section, which is located on the exterior of the sealing profile and covers the interior door trim. At least one contoured fin, which transmits the magnetic tensile force to the area of the sealing foot, is located inside the hollow cross-section.

The invention relates to a sealing profile, in particular for the door of a refrigeration appliance, said profile comprising a hollow cross section, a sealing chamber for a magnetic strip, a sealing foot installed on the inside of the door and a sealing section that is affixed to the outside of the sealing profile and covers the interior door trim.

Known sealing profiles of this type are installed along the door or lid of a refrigeration appliance by inserting the sealing foot into a circumferential groove on the inside of the door. To prevent an unsightly optical appearance in the area of the interior door trim, traditional sealing profiles of this type comprise for the most part a sealing section installed on the outside to the sealing profile, which can take the form of a sealing lip or bellows joint and covers the dirt joint that develops in the region of the interior door trim.

With refrigerators and freezers, the gap between the body and the door of the refrigeration appliance is sealed with the aid of magnetic door edge seals. A magnetic strip is inserted for this into the sealing chamber of the sealing profile, so that this section of the sealing profile fits along its complete length against a stop edge of the appliance body when the refrigeration appliance door is closed. However, it has turned out that the door gap is widened considerably as a result of unavoidable production tolerances. In particular, this problem occurs during the cold run, meaning when the refrigeration appliance is operational. The increases in the door gap can be compensated by using magnetic door edge seals. However, these caused a pulling apart of the sealing profile with varying force at different locations, so that the sealing section that covers the interior door trim is being lifted at some locations by the magnetic tensile force and the otherwise covered dirt joint becomes visible.

To remedy this problem, attempts have been made to produce the profile base region and the sealing profile section in the region of the sealing lip with a higher wall thickness. However, the material expenditure for this variant is relatively high. An attempt was furthermore made to produce sealing profiles with the two-material extrusion technique, wherein the profile base and the profile section in the region of the sealing element are made of a particularly stiff material. The two-material extrusion, however, is extremely involved and expensive.

It is therefore the object of the present invention to avoid the aforementioned disadvantages and to create a sealing profile where the lifting of the sealing section is avoided.

This object is solved according to the invention for a sealing profile of the aforementioned type by inserting at least one profile web into the hollow cross section, which transmissions the magnetic tensile force to the region of the sealing foot.

According to the invention, the highest share of the magnetic tensile force is transmissionred via the profile web from the region of the sealing chamber for the magnetic strip to the sealing foot, wherein only a small share of the force flow passes through the sealing profile section containing the sealing section. This share is low enough in any case so that the sealing section is not lifted up and the dirt joint remains covered. The sealing profile region containing the sealing section, for example a sealing lip or bellows joint, experiences virtually no forces, so that no displacements or movements can occur.

Yet, movements of sections of the sealing profile are possible in other regions, for example in the region of the sealing chamber which is pulled by the magnetic tensile force in the direction of the opposite arranged end stop of the appliance body and thus away from the sealing foot during the door closing. However, the profile web according to the invention that transmissions the magnetic tensile force to the region of the sealing foot prevents this movement from being transmitted to the hollow cross section in the region of the sealing section.

A particularly reliable seal is achieved if the profile web of a sealing profile according to the invention extends from the region of the sealing foot essentially diagonally to an essentially perpendicular section containing the sealing section or to an essentially horizontal section of the sealing profile that is located opposite the sealing foot. In this way, the force can be transmitted directly between the sealing foot and a perpendicular or horizontal section of the sealing profile, which in turn is connected to the sealing chamber. The region of the sealing section is thus mechanically “short-circuited,” meaning the force is not transmitted directly.

According to a different embodiment of the inventive idea, the sealing profile can be provided with a second profile web that starts at the first profile web and extends essentially diagonally to one corner of the sealing profile in the region of the profile base. The second profile web can extend from the center of the first profile web to the lower outer corner of the sealing profile. The first and second profile webs thus form a framework-type pattern, wherein the second profile web prevents a movement to the side of the first profile web and the sealing section. With little material expenditure, the resistance to displacements in the region of the sealing section is noticeably increased.

According to a different modification of the invention, the sealing profile is provided with a third profile web that starts at the first profile web and extends essentially in horizontal direction. The third profile web preferably starts in the center section of the first profile web and essentially extends in horizontal direction, up to a different section that is also connected to the sealing foot or to the hollow cross section of the sealing profile on the side opposite the sealing section. The third profile web prevents a movement to the side of the first profile web. The second and the third profile webs can meet in a common point and form a framework node, or they can be arranged so as to be displaced on the first profile web.

The sealing profile is advantageously provided with a fourth profile web which connects the essentially horizontal third profile web with the region of the sealing foot. In that case, the fourth profile web can transmit the magnetic tensile force transmitted by the third profile web into the sealing foot. The fourth profile web can be arranged essentially perpendicular, starting from the sealing foot, wherein this third profile web can have a shortened design and extend from the end point of the fourth profile web to the first profile web. The material requirement for this embodiment is very low.

According to another embodiment of the invention, an essentially bow-shaped fifth profile web can be arranged between the sealing chamber for the magnetic strip and the sealing foot or, if necessary, a profile section connected to the sealing foot. The fifth profile web can essentially be embodied parallel to the hollow cross section of the sealing profile. A specific share of the magnetic tensile force can be transmitted via the fifth profile web from the sealing chamber to the sealing foot, so that the region of the sealing section is additionally relieved of the force transmission. However, it is also possible to omit the fifth profile web, so that a higher share of the force flow is transmitted via the hollow cross section of the sealing profile to the sealing foot.

A particularly reliable and optically appealing covering of the dirt joint is achieved if the sealing section is designed as sealing lip or bellows joint. The sealing lip in that case can cover the dirt joint and/or edge even if the door of the refrigeration appliance is closed and the sealing profile is subjected to the magnetic tensile force. Alternatively, the sealing section can also be designed as bellows joint, meaning as an essentially half-round sealing chamber, which is installed on the outside of an essentially perpendicular section of the hollow cross section and fits flush against a surface or a projection on the inside of the door.

The wall thicknesses of one or several of the interior profile webs preferably are designed differently from the wall thickness of the sealing profile. In particular, the wall thickness of one or several interior profile webs can exceed the outside wall thickness of the sealing profile. By varying the wall thicknesses, the rigidity and thus also the deformation behavior of the sealing profile according to the invention can be influenced in many regions. A specific sealing profile can be designed for each desired deformation behavior.

Sealing profiles according to the invention can be produced from a plastic material, in particular they can be extruded.

The invention relates to a refrigeration appliance, in particular a refrigerator, freezer or chest freezer having a door provided with a sealing profile according to the invention. The sealing profile according to the invention, having the advantages as described in the above, can also be used for other appliances, devices and apparatuses that require a seal against heat, humidity or temperature.

Additional advantages and details of the invention follow from the exemplary embodiments and the Figures described below. The Figures are schematic representations which respectively show in the cross section:

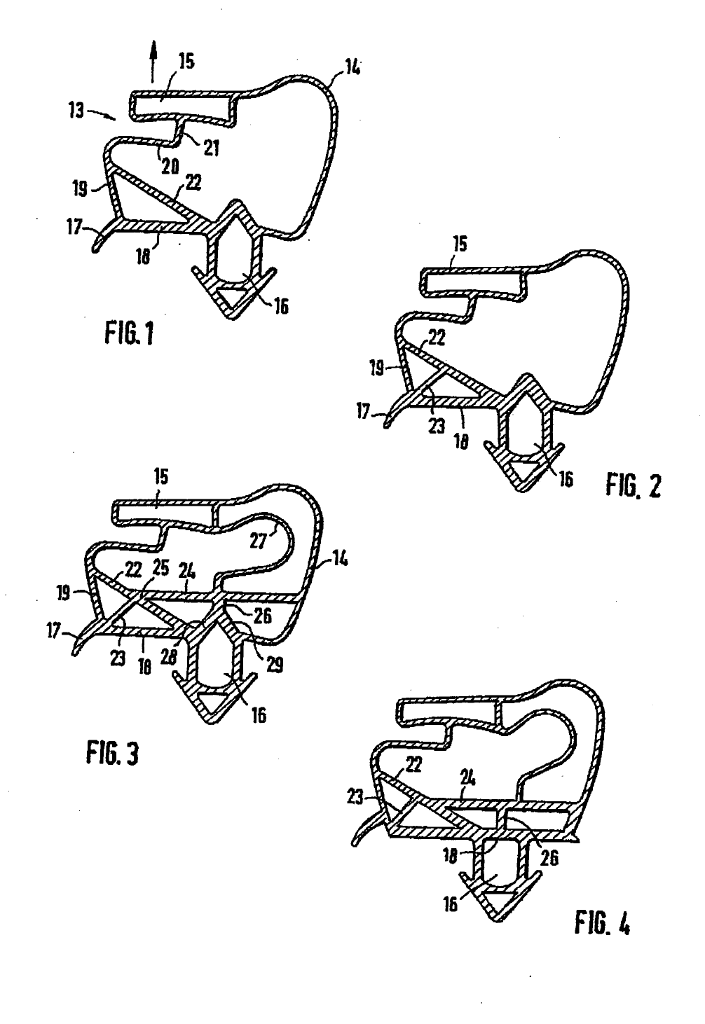

FIG. 1 A sealing profile with a first profile web;

FIG. 2 The sealing profile shown in FIG. 1 with an additional, second profile web;

FIG. 3 The sealing profile shown in FIG. 2 with a total of five profile webs;

FIG. 4 A similar sealing profile as the one shown in FIG. 3, with a changed force introduction into the sealing foot;

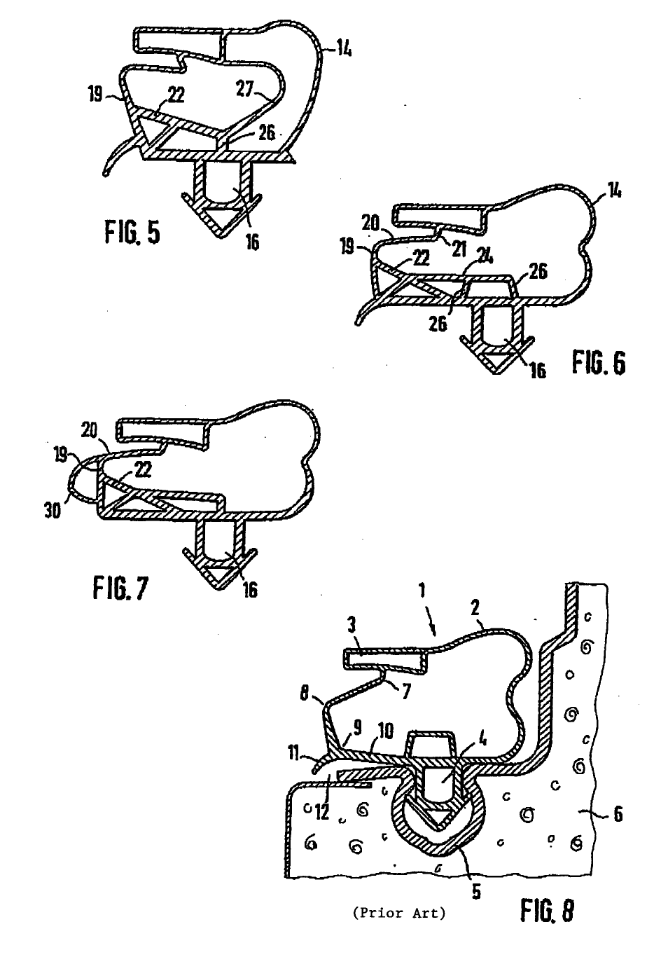

FIG. 5 A sealing profile for which the diagonally extending first profile web is connected to a perpendicular profile web in the region of the sealing foot.

FIG. 6 A sealing profile without bow-shaped profile web;

FIG. 7 A sealing profile with a sealing section designed as bellows joint;

FIG. 8 A sealing profile according to the prior art.

For a better understanding, we first want to discuss briefly the disadvantages of the prior art as shown in FIG. 8. The sealing profile 1 with its hollow cross section 2, forming the sealing chamber 3 for a magnetic strip, is pressed jointly with the sealing foot 4 into a circumferential groove 5 on an interior door 6 of a refrigeration appliance. As a result of the magnetic tensile force, the relatively flexible sealing profile 1 is pulled apart, in particular at the hinged locations 7, 8, 9, wherein the profile section 10 that originally fits flush against the interior door is lifted up, so that the external sealing lip 11 lifts up and the dirt joint 12 becomes visible.

The sealing profile 13 according to the invention, shown in FIG. 1, essentially consists of a hollow cross section 14, a sealing chamber 15 for a magnetic strip and a sealing foot 16 which can be inserted into a circumferential groove of a door for a refrigeration appliance. The sealing profile 13 furthermore is provided with a sealing means in the form of a sealing lip 17 that is arranged on the outside.

The essentially horizontal profile section 18 that starts from the sealing foot 16 is followed by an approximately perpendicular profile section 19 of the hollow cross section 14, which is connected via a horizontal profile section 20 and a perpendicular profile section 21 to the sealing chamber 15. A first profile web 22 extends from the upper part of the profile section 19 diagonally to the region of the sealing foot 16. During the closing of the door, the sealing chamber 15 is moved with the magnetic tensile force in the direction of the arrow while the sealing foot 16 that is clamped inside the groove remains unmoved. The magnetic tensile force is transmitted to the sealing foot 16, in part via the outer section of hollow cross section 14 on the right side of FIG. 1, as well as via the profile sections 21, 20 on the left side of FIG. 1 and the upper part of the profile section 19 and the first profile web 22. The remaining regions of the sealing profile 13 are essentially force-free, in particular the lower part of the profile section 19, the sealing lip 17 and the horizontal profile section 18, so that virtually no movements or displacements occur in these regions. The portion of sealing profile 13 that contains the sealing lip 17 does not, or at most only slightly contribute to the transmission of force from the sealing chamber 15 to the sealing foot 16. In contrast to traditional sealing profiles, no undesirable lifting of the sealing lip 17 can thus occur.

FIG. 2 shows the sealing profile according to FIG. 1 with an additional second profile web 23, which starts at the corner that is formed by the horizontal profile section 18 and the perpendicular profile section 19. The sealing lip 17 is arranged at this corner and extends approximately to the center of the first profile web 22. The second profile web 23 is arranged diagonally and prevents a movement of the first profile web 22 when this profile web is subjected to the magnetic tensile force. As a result, the second profile web 23 increases the rigidity of the sealing profile.

In addition to the first profile web 22 and the second profile web 23, the sealing profile shown in FIG. 3 is also provided with a horizontally extending third profile web 24 that starts at the first profile web 22. For the exemplary embodiment shown herein, the third profile web 24 forms a joint nodal point 25 together with the first and second profile webs 22, 23, while its opposite end extends up to the hollow cross section 14, meaning to the outside of the sealing profile.

A fourth, perpendicularly extending profile web 26 connects the third profile web 24 to the sealing foot 16. A bow-shaped fifth profile web 27 is formed above the fourth profile web 26 and is connected to the sealing chamber 15. Accordingly, the magnetic tensile force can be transmitted from the sealing chamber 15 via the fifth profile web 27 and the fourth profile web 26 to the sealing foot 16. The highest share of the magnetic tensile force is transmitted to the sealing foot 16 via the multiple load paths formed by the first to the fifth profile webs. For that reason, the corner region with the sealing lip 17 does not move, even if the magnetic tensile force is effective, because the force is not transmitted via the profile sections 19, 18.

FIGS. 4 to 7 show further modifications of sealing profiles. With the sealing profile shown in FIG. 4, the force is introduced differently into the sealing foot 16 as compared to FIG. 3. While the fourth profile web 26 in FIG. 3 is connected to two diagonally extending webs 28, 29, which are respectively connected to one side of the sealing foot 16, the fourth profile web 26 of the exemplary embodiment shown in FIG. 4 extends up to the horizontal profile section 18 that forms the profile base. In contrast to the sealing profile shown in FIG. 3, the second profile web 23 and the third profile web 24 do not intersect at a joint nodal point, but are displaced relative to each other along the first profile web 22.

FIG. 5 shows a sealing profile without a third, horizontally extending profile web. The first profile web 22 extends from the center of the outer profile section 19 to a nodal point formed by the perpendicular profile web 26 and the bow-shaped fifth profile web 27. This embodiment is distinguished by a low material use.

FIG. 6 shows an exemplary embodiment of a sealing profile without a bow-shaped fifth profile web. The magnetic tensile force is therefore transmitted on the one side via the hollow cross section 14 to the sealing foot 16. On the other side, the force is transmitted via the profile sections 21, 20, the upper part of the profile section 19 and the first profile web 22 directly and/or via the horizontal third profile web 24 and essentially perpendicular fourth profile webs 26 to the sealing foot 16.

The sealing section for the sealing profile shown in FIG. 7 is designed as a bellows joint 30. The bellows joint 30 has an approximately semi-circular cross section and, in the installed condition, fits with its outside against a projection of the interior door. The diagonally extending first profile web 22 can be arranged in the upper part of the essentially perpendicular profile section 19, as shown in FIG. 7. However, it can also extend between the corner, formed by the profile sections 19, 20, and the region of the sealing foot 16.

The inventive idea also comprises additional useful combinations of the individual characteristics, even if they are not explicitly described.

1. A sealing profile, in particular for the door of a refrigeration appliance, said profile comprising a hollow cross section, a sealing chamber for a magnetic strip, a sealing foot that can be installed on the door inside, and a sealing section that is arranged on the outside of the sealing profile and covers the interior door trim, characterized in that at least one profile web (22) is arranged inside the hollow cross section (14) and transmits the magnetic tensile force into the region of the sealing foot (16).

2. The sealing profile according to claim 1, characterized in that the profile web (22) extends from the region of the sealing foot (16) essentially diagonally to an essentially perpendicular section (17) that contains the sealing section or to an essentially horizontal section (20) of the sealing profile (13), which is positioned opposite the sealing foot (16).

3. The sealing profile according to claim 1, characterized in that it has a second profile web (23) that starts at the first profile web (22) and extends essentially diagonal to a corner of the sealing profile (13) in the region of the profile base.

4. The sealing profile according to one of the claim 1, characterized in that it has an essentially horizontal third profile web (24) that starts at the first profile web (22).

5. The sealing profile according to claim 4, characterized in that it is provided with a fourth profile web (26) that connects the third profile web (24) to the region of the sealing foot (16).

6. The sealing profile according to claim 5, characterized in that the fourth profile web (26) is arranged essentially perpendicular.

7. The sealing profile according to claim 1, characterized in that an essentially bow-shaped fifth profile web (27) is arranged between the sealing chamber (15) for the magnetic strip and the sealing foot (16), if necessary a profile section connected to the sealing foot (16).

8. The sealing profile according to claim 1, characterized in that the wall thickness of one or several of the interior profile webs exceeds the outside wall thickness of the sealing profile (13).

9. The sealing profile according to claim 1, characterized in that the sealing section is designed as sealing lip (17) or bellows joint.

10. The sealing profile according to claim 1, characterized in that it can be made from a plastic material and, in particular, can be extruded.

11. A refrigeration appliance, in particular a refrigerator, freezer or chest freezer, characterized in that it has a door provided with a sealing profile according to one of the claim 1.
